(19) United States
(12) Patent Application Publication
(10) Pub. No.: US 2014/0244314 A1
(43) Pub. Date: Aug. 28, 2014

(54) SYSTEM AND METHOD FOR ASSET MANAGEMENT

(71) Applicant: ENCIRCLE INC., Kitchener (CA)

(72) Inventors: Paul DONALD, Petersburg (CA); Ronuk RAVAL, Mississauga (CA); Christophe BIOCCA, Montreal (CA)

(73) Assignee: ENCIRCLE INC., Kitchener (CA)

(21) Appl. No.: 14/183,981

(22) Filed: Feb. 19, 2014

Related U.S. Application Data
(60) Provisional application No. 61/770,401, filed on Feb. 28, 2013.

(51) Int. Cl. G06Q 10/08

(52) U.S. Cl. CPC G06Q 10/087; G06Q 40/08
USPC 705/4

(57) ABSTRACT

A system and method for asset management and, in particular, cataloguing, organizing, analyzing, utilizing and managing the contents of a building is disclosed. The system involves a process for using various means to capture the assets/contents of an organization/building. One key goal of the cataloging of a building's contents is to establish an insurable amount of assets within the building. Additionally by organizing the task it can be made easier and more foolproof. Once assets have been added to the system, methods are provided to better utilize the information and add value by using the system.

### FIELD

A system and method for asset management and, in particular, for cataloguing, organizing, analyzing, utilizing and managing the contents of a building is disclosed.

### BACKGROUND

The problems of categorizing a building's contents are well known. The insurance industry typically requires proof and assurances of contents when insurance claims are made. Insurance fraud is a challenge for the insurance industry, increasing costs and insurance premiums. Existing systems exist for simple recording of building contents, usually through photographic means, that can be used later to provide confirmation of a building's contents. These types of systems typically perform a solution to one problem and extend no further beyond capturing photos about the contents of the building itself.

Another common problem faced by businesses and consumers is the management of major assets. Such assets include appliances, tools, machinery and other major purchased items that can reside within a building. Conventional solutions typically allow users to manually input manufacturers name and product information about assets in order to gain access to support information, product malfunctioning issues, troubleshooting, and parts ordering. These solutions may allow a user to type in manufacturer name and model and serial number information and get useful information about their product.

Another problem facing businesses and consumers is ensuring items in their inventory are not subject of an involuntary or voluntary recall. Often appliances in homes are not identified until there is a fire or other tragedy. There is generally no effective method of proactively notifying the consumer about a recall after they have made a major purchase. One exception is the automotive industry where purchases are tracked and recall letters are mailed out to individuals that have a specific make and model of vehicle. There is, at least one online user driven service that allows a person to manually input product type, manufacturer name, model numbers and serial number and wait 24 hours to get feedback on whether such a recall has happened on their product.

Conventional systems do not offer a comprehensive solution to the problem of cataloguing, organizing, analyzing, utilizing, and managing the contents of a building. Not only do conventional solutions have no relationship to each other but their operations cannot be merged. Additionally they generally fail to address larger problems around asset recalls, maintaining and advising on maintenance of the asset and providing solutions when repairs are needed. These solutions may not take into account changes in current technology with respect to social media and the like.

Another challenge for insurance users is the problem of finding the insurance balance between the exterior structure and the interior contents. Insurance policies make arbitrary estimates on how much insurance to apply to the exterior of the home or business and the internal contents. These arbitrary insurable levels may not be correct and there is no easy method for the home owner or business owner to correct these levels to the mutual satisfaction of themselves and the insurance companies offering them the insurance. Insurance companies may want some level of proof or some level of assurance that fraud is not being perpetuated upon them.

### SUMMARY

To attempt to address these concerns and problems a system and method for asset management and, in particular, cataloguing, organizing, analyzing, utilizing and managing the contents of a building is disclosed. The system involves a process for using various means to capture the assets/contents of an organization/building. One key goal of the cataloging of a building's contents is to establish an insurable amount of assets within the building. Additionally by organizing the task it can be made easier and more foolproof. Once assets have been added to the system, methods are provided to better utilize the information and add value by using the system.

In particular, the contents can then be further categorized and analyzed using various methods. Once the contents are analyzed they can be leveraged to provide additional solutions to the stated problems. Various methods for managing categorized assets are also disclosed. These methods including the ability to collect known information about an asset, including manuals, known problems, service options, repair videos and recall information. Additionally social interaction with other owners of similar assets can be undertaken. Such interactions can uncover common shared problems and issues, useful repair information, user experience and tricks to get maximum use from the asset. Beyond this shared experience brings a vast range of other socially related advantages to owning a socially connected asset and maximizing the value of that asset.

### BRIEF DESCRIPTION OF THE DRAWINGS

FIG. 1 is an overview of the embodiment showing all the components needed by the system.

FIG. 2 is an illustration of a specific implementation of an exemplary system where all the components of the system can be utilized.

FIG. 3 is an illustration showing components within the Asset Management Service.

FIG. 4 is an illustration showing an exemplary computer display showing different buildings managed by a single person.

FIG. 5 is an illustration showing an exemplary display of different assets within a room.

FIG. 6 is an illustration of capturing a particular asset within a specific room.

FIG. 7 is an illustration of a particular asset.

FIG. 8 is an illustration of performing special asset requests.

FIG. 9 is a flow chart for the operation of the system.

FIG. 10 is a flow chart showing the reception of a new asset from an external source.

FIG. 11 is a flow chart showing how a new service provider is added to the system.

FIG. 12 is a flow chart showing the user making a request for service.

FIG. 13 is a flow chart showing a user of an asset joining a social media group.

FIG. 14 is a flow chart showing a question or query arriving from the user about an asset.

### DETAILED DESCRIPTION

A system is disclosed providing methods to capture and catalogue the contents of a home or business. The availability of such a capture and cataloguing system would be beneficial for the insurance industry. During the process of capturing the contents of a building, additional methods are provided for organizing and analyzing the information. The process of analyzing the contents may improve accuracy and provide additional data into the system. With this additional data, further utilization methods are disclosed for leveraging the information.

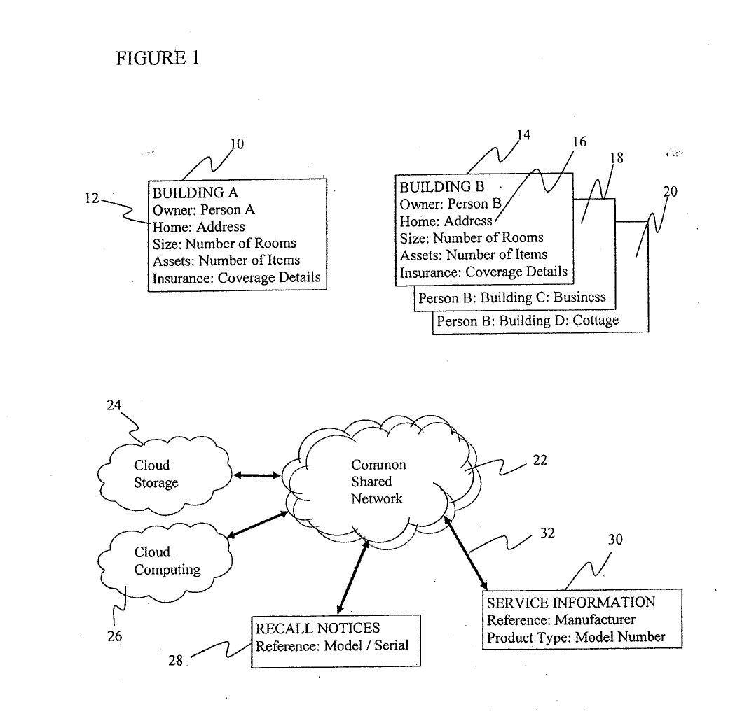

Turning to FIG. 1 there is an overview of the embodiment showing all the components needed by the system. In this representation there are buildings 10, 14, 18, 20 where contents are being held. Such buildings 10, 14, 18, 20 might be a business, home, farm, cottage, airplane hangar, a workshop or a multitude of other structures where personal contents and assets are contained. Assets can be divided into those assets with no identification information on them, termed simple assets for this disclosure, and those assets that have tagging information on them, called structured assets for this disclosure. An example of a simple asset might be a chair in a kitchen. Such a chair might have a style, color or size, but it does not have a model number, serial number, a Quick Response code (QR code) or Universal Product Code (UPC) bar code on it. A simple asset can be upgraded to a structured asset if a code was attached to it, like a radio frequency ID (RF-ID) commonly used in the retail industry. Structured assets are generally more expensive and an example might be a refrigerator, with clear manufacturer information like model number and serial number, QR code, UPC code, RF-ID tag, Subscriber Identity Module (SIM) card inserted or some other key identification feature. For ease of reference both these types of assets will be termed assets within this disclosure to refer to both structured and simple assets.

In this exemplary illustration Building A 10 could be Person A's house 12. Whereas Building B 14 might be Person B's home 16. Person B might also have a business he owns 18 and a cottage as well 20. Each building 10, 14, 18, 20 has properties to identify it 12, 16. Such properties could include a wide range of identifications like building name, address, size, number of rooms, number of floors, GPS co-ordinates, insurance policy number, insurance policy coverage amounts, and many other such details. Also within each building would be a collection of assets. Each assets itself may be further categorized and identified using other properties. Each building stands alone within the system and its identifying features are not known to other components of the system.

Also available within the exemplary embodiment would be a common shared network 22, like the Internet that is available for communication use. It links up services like Cloud Storage 24 services and Cloud Computing 26 services. Also found on a wide area network like the Internet are various information sources 28, 30 that hold recall information notices 28 and service information 30. Linkages to these services 32 might be well known physical Ethernet cables running protocols like TCP/IP, wide-area wireless networks like GSM, Edge, LTE and local area wireless networks based on 802.11 protocols like WiFi networks.

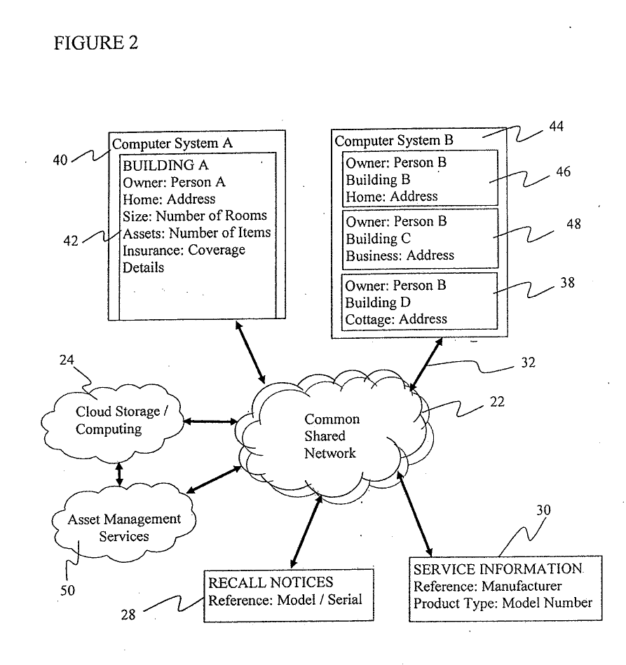

Turning to FIG. 2 there is an illustration of a specific implementation of an exemplary system where all the components of the system can be utilized. The logical contents of each building are now available within computer system A 40 and computer system B 44 to maximize the utility with other known systems. The computer system could range from a desktop computer, to a laptop computer, tablet computer, a smartphone computer or a range of the above computer systems. The type of computer and user interface selected is open to design based on the needs of the user and the type of assets being managed. In this exemplary embodiment the computer system runs a specialized asset management software program on a processor. The asset management software program allows the user to log into the system, acquire a view of all their buildings and assets. In this system it might be possible to photograph the assets with a smartphone and then input larger amounts of data on a laptop computer. This software allows management of a user's assets to perform actions like adding and removing buildings, adding and removing assets and interacting with other users via social network links based on assets they have captured within the system. It will be understood that elements of the asset management software program may be distributed and run on a plurality of processors.

In this illustration computer system A 40, holds the logical contents of building A 42, captured using various means. Computer system B 44, hold the logical contents of building B 46, building C 48 and building D 36, all owned by the same person. The term holds can also imply that computer system A 40 and computer system B 44 hold a cache of information to be viewed and modified. Using a feature rich client and an intelligently managed caching model is well known in the computer industry and is one exemplary embodiment for the current system. In such systems the client retrieves records from the server as needed to present information to the user on the current computer they are logged in through. As more records are accessed, expanded or added the cache grows and information is stored at the server. These computer systems 40, 44 communicate to a common shared network 22 using a communication means 32. The communication could be through wired or wireless network methods well known in the industry. The common shared network could be several networks for example an LTE communication network connected via a network router to a larger network like the Internet.

Computer systems A and B 40, 44 also make use of other computer services through the common shared network 22. In exemplary embodiments the Computer systems A and B 40, 44 might require external storage and computing service 24. Such generic services are commonly used when large amounts of data exist or when complex computing operations are required. External storage may be used to deal with back-up copies of important information and share information between other users of the system or with insurance companies. When serious loss of property takes place it is a consideration to have offsite storage of information to protect the information from harm. Such external cloud computing service might be utilized to perform advanced optical character recognition (OCR) scans of photographs taken of structured assets within a home or business. If systems A and B 40, 44 are slower smartphone type devices such external computing services 26 might make the difference between providing OCR services or forcing the user to manually enter every model number and serial number. OCR service can also reduce errors that often take place with manual input of long number sequences.

In an exemplary embodiment computer systems A 40 and computer system B 44 will use Asset Management Services 50, designed and created to perform complex management of buildings and assets. It is also commonly understood that in a complex system it is also possible to build a direct relationship between Asset Management Service 50 and cloud storage and computing service 24. In such an embodiment the complexity of computer system A 40 and computer system B 44 are reduced as they can interact with a single source of information, services and computing power 50. In an exemplary embodiment the Asset Management Service 50 is acting as the hub of activity within the asset capture and management system.

In an exemplary embodiment assets are added to the system via different avenues, depending on the asset type, structured or simple, and the location it is purchased in. Once structure assets enter the system they can then be analyzed by the Asset Management Service 50 using of external sources of information like Recall Notices 28, for example within government recall web sites like: www.recalls.gov. Additionally the Asset Management Service 50 can perform advanced searches to identify locations for service information 30. Service information 30 might include parts, warranty, product videos, user manuals, service depots and other helpful information to owners of structured assets. In collecting this information the Asset Management Service 50 performs web scraping, merging and analysis, to build relevant and usable database information for all users of the system. Such information collected by the Asset Management Service 50 is automatically replicated to all applicable assets within the system and presented to computer system A 40 and computer system B 44 when the building and assets are accessed for viewing.

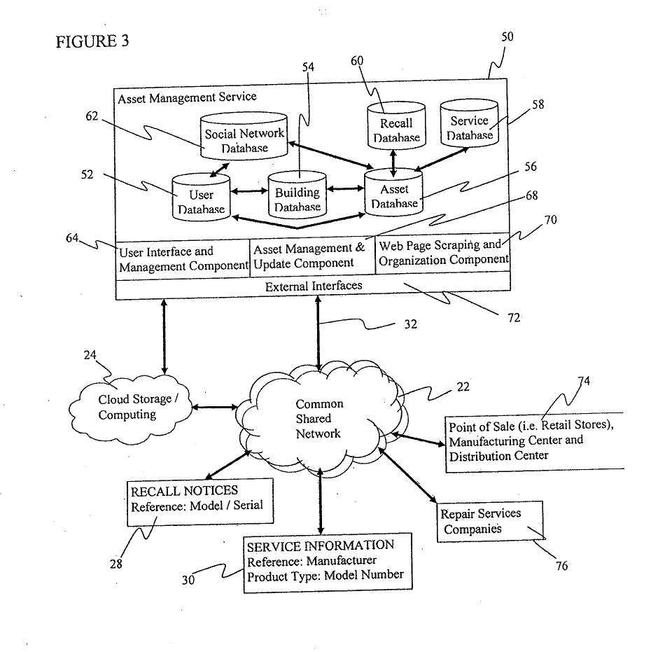

Turning now to FIG. 3 there is an illustration showing components within the Asset Management Service 50. Users of the system gain access through the User Interface and Management Component 64. In an exemplary embodiment users can access the system using a variety of computer systems. The User Interface and Management Component 64 also handles content translation, also known a transcoding. Transcoding makes up another element of the Asset Management Service 50.

Users can be individuals who own home, stores, businesses, farms, cottages and any other physical building structures. A user of the Asset Management Service 50 can also be retail stores, manufacturing center or distribution center 74. In an exemplary embodiment these users are inserting assets into the Asset Management Service 50 on behalf of an individual or company that has just purchased a specific asset. This automatic insertion of an asset from a retail store is expanded in later diagrams. In an exemplary embodiment there are many ways to get assets into the system for management.

As users define themselves into the system and are added to the user database 52, they can start to add buildings to the building database 54. Within each building assets can be added to the asset database 56. For one skilled in the art of databases it is clear these databases could be separate or integrated depending on their size and inter-relatedness. Assets can also be added to the asset database 56 via a retail store for example. In this case the retail store adds it on behalf of a known user in the system and when the user gets the asset into a building they can assign that asset to a room, floor, stall, hangar, cubical or some other location within the building.

As assets are acquired into the Asset Management Service 50 the asset management and update component 68 will make specific requests from the web page scraping and organization component 70. This process involves locating information depending on what the user requests, the designs of the system and what available information can be found in commonly held locations. Usually such locations are found on public networks like the Internet, or within private databases stored within companies. Information is first detected on public sites the web page using scanning and scraping techniques to match identification information like manufacturer name, model number, serial number, QR code, UPC values or other standard. Once information is found, for example a Recall Notice, the extraneous information within the notice must be stripped away and the core message, model number, serial number and reasons for the recall are extracted. This information is then integrated with other existing information for that asset and it is added to a specific database, like the Recall database 60.

Another example of this process would be for service information. The web page scraping and organization component 70 would find service information, warranty information, manuals, problem reports, video tutorials and a wide range of other service information and integrate this material into the service database 58. Similar procedures could be added to allow repair service companies to become users in the system. When assets are added to the system and serious problems occur, the owner of the asset might be provided a list of accredited repair service companies 76 to repair the problem. Similar procedures could also be required for other specific assets and additional databases may be built for these. For example there could be a lost and found database for assets like cell phones that have been lost and the asset is trying to be returned based on its subscriber identity module (SIM) card number. Further details on how service providers make themselves known to users of the system is provided in later diagrams.

To support all this activity, the external interface 72 might use various public or private connection methods to reach either public or private data necessary to support the assets within the system. Storage of all building and asset information within the asset management center 50 allows for problems like fire, hurricanes, tornadoes and floods to not affect the information when it is most needed for insurance purposes. If the data becomes too large it can be moved into the cloud storage and computing service 24.

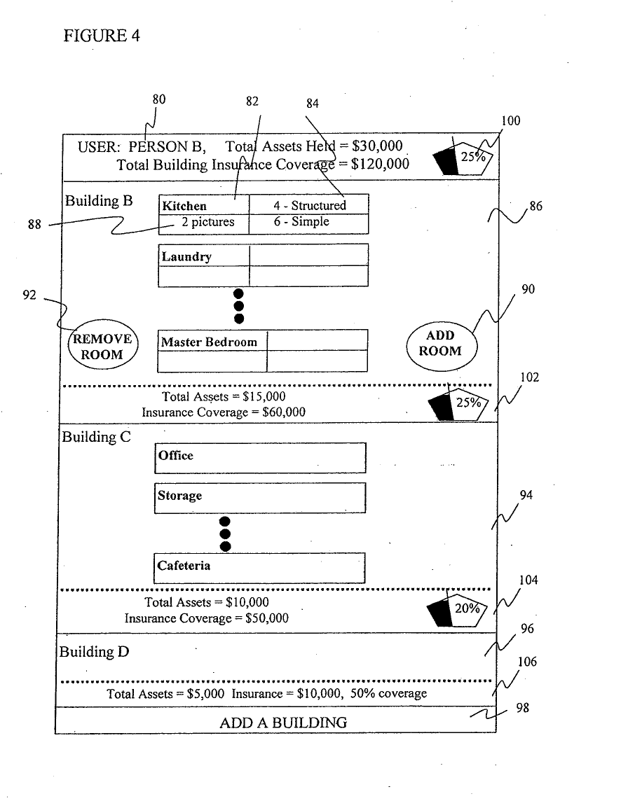

Turning now to FIG. 4 there is an illustration showing an exemplary computer display 80 showing different buildings managed by a single person, Person B 80. The title of the display could show many different elements, for example the number of buildings, their location, the last time the user logged into the system and similar fields. In this exemplary embodiment the title area 80 shows the user's name, their total assets across all buildings and their current insurance coverage amount for all buildings owned 80. Additionally this embodiment shows a simple pie chart 100 given the user a visual indication that they have used up only 25% of their total insurance coverage for inside all their owned buildings. Similar total assets and insurance coverage per building can also be provided to the user 102, 104, 106. In other embodiments words might be used without charts and graphs 106. When a user creates a building they have the option of inputting the insurance coverage values for the contents of that building. Then as assets are accumulated the numbers are compared and different charts, diagrams and symbols can be used to tell the user where their insurance coverage levels fit with respect to the assets they own in that building.

In this illustration Building B 86, Building C 94 and Building D 96 are represented. Adding another building could be easily achieved by adding buttons or menu choices 98. The format and choice of layout are for illustration only and many user interfaces could be used to represent the assets within a building. In this exemplary illustration each building has a series of rooms 82. Each room 82 provides a small summary of the assets within the room 84. Also included is a field showing the total number of photographs taken within the room 88. In other embodiments the assets of a building could be represented by different floors, different segments of a building or in other cases it could be hangars within the building. The design of the user interface is flexible and the interface selected could match the type of assets being captured and categorized.

In this embodiment Building B 86 contains at least a kitchen 82, laundry and a master bedroom; other rooms are implied but not shown in this illustration. In an exemplary embodiment the interface would allow the user to automatically add a room 90 and remove a room 92 with simple command interface option 90, 92. Using a touch screen interface, menu system or a mouse click the user could simply add or remove a room, select the room and then add different types of assets into the room. Maneuvering around selection boxes, selecting, deleting, adding and modifying is well known in the art of user interfaces. Such a procedure then updates the room status boxes to show what has been done thus far. All such actions performed on the local computer system screen 80 would be replicated to the asset management center 50 for storage, organizing, analysis and management.

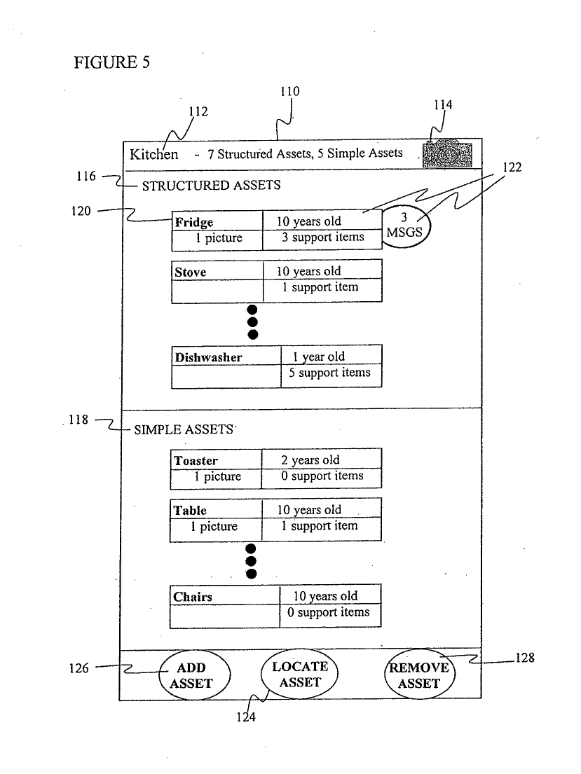

Turning now to FIG. 5 there is an illustration showing an exemplary display 110 of different assets within a room. As with previous user interfaces the layout of the display can have many variations and formats. Information to be displayed comes from the local cache currently in use. In this embodiment the cache is updated and kept fresh by the asset management service 50 based on the user's login credentials and their menu selections. In this embodiment assets are collected into rooms within the building, in other embodiments the assets could be associated to a floor within the building, a quadrant, a stall or even a hangar. In this embodiment the user has added a building as shown in FIG. 4 and added rooms to that building. One such room was the kitchen 112 shown in FIG. 4 with 7 structured assets and 5 simple assets. Each asset can be added individual and given properties based on its complexity and identifying characteristics. Assets with tagging information like a manufacturer type, model number, serial number, UPC bar code, QR tag or other industrial identification information are considered structured assets 116. Assets with no tagging information, like table, chairs, furniture, rugs and other untagged information are considered simple assets 118. Also available in this embodiment is a camera icon 114 that provides a method for the user to directly open any room photographs that have been taken.

Assets can be added through various methods depending on the computer capabilities. Adding or removing assets can be performed through touch screen menus or buttons 126, 128 as needed by the user. In this embodiment structured assets 116 are listed first with summary boxes showing the asset name 120 with additional asset characteristics 122. In an exemplary embodiment adding assets include photographing the model number/serial number name plate, zooming in on the numbers and manually entering them through a dialogue box.

The additional characteristics 122 can include a wide range of choices such as appliance age, number of pictures taken of the asset, available support items retrieved, any recall notices detected and other such information. Also shown in the characteristics section is a message count indicator 122. This indicator 122 is used when message are exchanged through the social media connection to other users. When another user in the system, having the same appliance type, has an issue, question or wants to open a discussion they can exchange a message about the appliance. Further details are provided in subsequent diagrams for this functionality.

In this exemplary embodiment the simple assets 118 follow the structured assets 116. A list of asset names and properties follow in a similar pattern as shown for both simple 118 and structured assets 116. For illustrative purposes not every asset is shown within this illustration but implied with three dots ( . . . ).

In those embodiments where assets are added using advanced methods a locate asset 124 menu option is provided. There are examples where an asset has been added to the asset management service 50 and has been associated to the user's account. For example they might have purchased the asset at a retail store that has direct linkages to the asset management service 50. When the user leaves the store with the asset, the identification information is provided with the user's name information to the asset management service 50. Then when the user performs a locate asset they are given a list of all unassigned assets within their ownership. In another embodiment a house sale has taken place and the appliances have been included with the sale. The first owner of the appliances checks them out of the current building and ownership and assigns them to the new owner. When the new owner arrives into the home they select the Locate Asset 124 button and the appliances appear and can be assigned into different rooms wherever the new owner decides to install them. This could be done with televisions, stereo equipment and smaller appliances like microwaves and toasters.

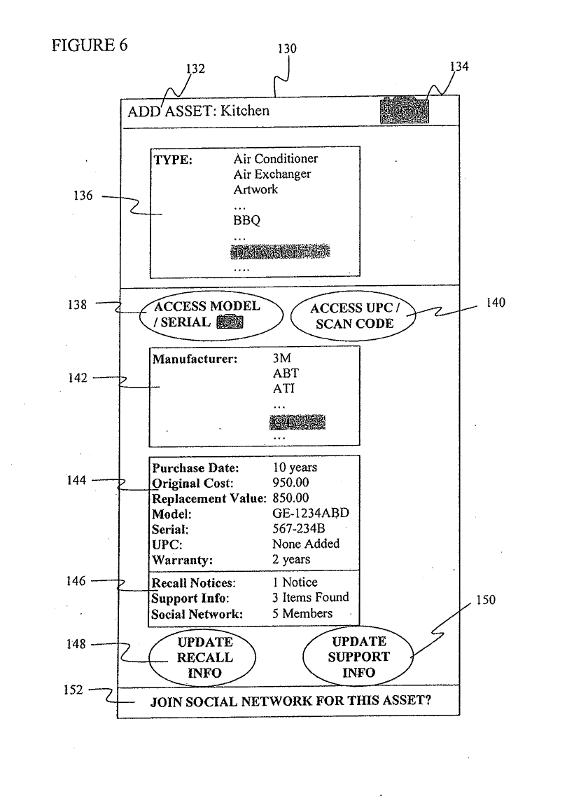

Turning now to FIG. 6 there is an illustration of capturing a particular asset within a specific room. In this example a computer screen 130 allows the user to add an asset to the kitchen 132 as shown. In this embodiment the user interface selected allows the user to manually request a picture 134 be taken of the asset. In other embodiments the picture might be mandatory and is taken upon entering this add screen for the first time. As part of the process the user details the information they know or have about the asset. First they start with a categorization from a pick list 136 to give the asset a type. In other embodiments the picture of the room can be sent to another process on the asset management service 50, on the local computer or the cloud computing service 26 to perform identification scanning. Such advanced scanning is already well known for facial recognition in airports and businesses. Performing scanning the picture for known assets like appliances, TVs, stereos, tables, chairs and many more may be available.

If a model number 138, serial number 138 or scan code 140 is accessible on the asset it will be promoted to a structured asset. Without any of these codes the asset is kept as a simple asset. As part of the accessing the model and serial number 138 the user will be requested to photograph the model and serial number plate on the asset. This is illustrated by the camera icon 138. In other example the user might automatically be prompted to photograph the model and serial number plate. Similarly the user selects to access the universal product code (UPC). In an exemplary embodiment taking a photograph of a QR code will automatically transfer the model and serial number over to the computer. Currently QR codes are capable of holding information like web page addresses and the amount of information a QR code can hold is expanding. Similarly taking a photograph of a UPC could automatically be interpreted by a currently sold smartphone to produce the necessary model and serial number information.

When necessary the user can also re-enter the model and serial number area 138 to modify, change or even remove model and serial number information. In one exemplary embodiments the photographic taken is then presented to the user who can use on-screen touch comments to expand and blow-up the photograph (two finger zoom used on touch-screen devices). They are then given a dialogue box to manually enter the model number and serial number to match what they see. In other exemplary embodiments the computer itself, the asset management service 50 or the cloud computing service 26 is given the picture where optical character recognition software scans the picture and picks up letters and characters that the user will be asked to be confirmed later. In this way the problems of manually entering an incorrect number or letter are reduced. In other embodiments the user has a smartphone or superphone with Near Field Communication (NFC) support and they touch the device to the asset to receive the model number and serial number. In other embodiments the asset could be tagged with an RF-ID which has been logged into the system and as it passes a scanner the appropriate information is gathered and passed to the asset management service 50. In all cases as information is gathered it is collected, stored, processed, analyzed and managed by the asset management service 50.

In this exemplary embodiment the next screen section 144 provides further details on the asset. Whatever the user has knowledge of can be entered into this area. This is not an exhaustive list of every characteristic possible for assets but a representative collection of trails that might be common for adding a dishwasher to a kitchen. When the model number and serial number are input they show up in the labeled area.

In this embodiment the user is also given buttons to update information that might be located by the asset management service 50. If the user has just entered a structured asset including its model number and serial number, these buttons may cause a search to take place on the asset management service 50. In an exemplary embodiment such an update request for recall information 148 could cause an additional screen to pop up to the user with the requested information. In other embodiments the number of recall notices 146 might automatically be updated. Similar behaviors could be seen when a request to update support information 150 is requested. Having these buttons might also allow the asset management service 50 to charge extra for such advance searches, similar to taking an International Standard Book Number (ISBN) and requesting detailed information from the library of congress. In exemplary embodiments these searches happen automatically and whatever information was found is summarized in the summary section 146.

Finally the addition of the new asset allows the user to join a social network related to this asset 152. This step might be optional or automatic depending on the embodiment selected. This might check a common database within the cloud computing database 26 to determine how many other users have a similar appliance. Designers of such a social network could also add smart networking features into the service to limit the total number of members. For example the software should be able to limit the number of participants if necessary using age of the asset, type of the asset and even model number of the asset. In the situations where very few people have the same asset as the one being added then anyone with a dishwasher from GE might be added. If the number of members is large then only people with 10 year old GE dishwashers with a common model number might be added to that social network. In this way the software designer can create a useful benefit to the user without overwhelming them with too much information.

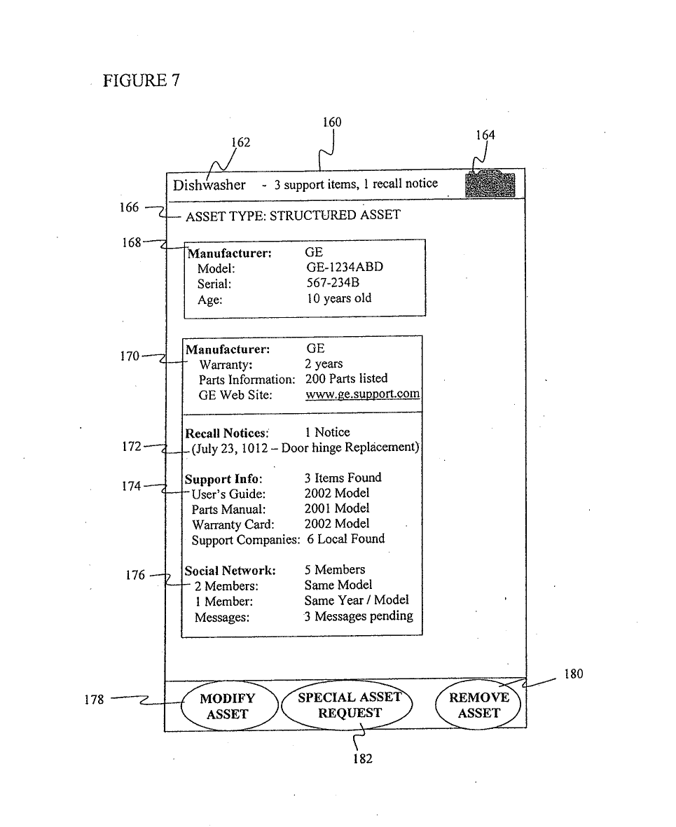

Turning now to FIG. 7 there is an illustration of a particular asset 160. This detailed computer screen 160 shows the dishwasher added in FIG. 5. This is one sample screen embodiment where the title or name of the asset is listed 162 including any important characteristics that have been added about the asset. In this embodiment the support items found and the recall notices 162 are listed. The user can also select the camera 164 to see or update the photographs taken for this asset.

Based on the input created when originally adding the asset it has been classified as a structured asset 166. The first box provides an initial overview of the most common information 168, including the manufacturer, the model number and the serial number.

The second display box 170 also shows manufacturer and other related information about the appliance including a support web site. In the final display box the information gathered from other sources is listed. The first item in this final display box includes the recall notices found 172 and a summary of what the recall notice relates to. The second item is the support information 174 and a brief listing of the manuals, videos, parts lists, warranty information and the service companies found. In a touch screen computer embodiment the user touches the item to open a detailed view. For example by touching the support companies the 6 companies found would be listed in detail with name, address and other relevant information. This is not meant to be an exhaustive list of all possible support items, but representative of common support items that might be found for appliance type assets.

The final section shown within the last box is the social network 176 membership. When the user agrees to join a social membership they are matched against other users of the computer system who have related assets. The number of members found is listed including their relationship with the asset listed. In other embodiments the listing might include the location of the members, their names, their appliance models and ages or a wide range of other relative fields. If the user selects to enter this social network area they will be given a chance to exchange messages, questions and resolve issues they might be facing with the asset. In an embodiment, the number of outstanding messages for this appliance is also displayed.

Finally in an embodiment, three on screen buttons are provided to modify the asset's detailed information 178, to remove the asset completely 180 or to make a special asset request 182. The special asset request 182 is for some unique asset event, for example the asset might have been sold, given away, but whatever has taken place the asset is no longer in this room. If the user still owns the asset then perhaps it has changed rooms. In other embodiments, the user might have to delete the asset from this room and re-add the asset to another room.

In other exemplary embodiments the special asset request 182 button might also allow the user to remove the asset from the system and give the asset to another user in the system. For example, on the sale of the house, the user may no longer want it associated with their login account and rather have it assigned to another login account. The user might want to check the asset out of the system and move it to an online sale site. In this case the asset management service 50 would collect the information about the asset and automatically moving it into eBay™ or Kijiji™ or a similar online site for sale. The user might also want to donate the item to an organization like Habitat for Humanity™ which would be handled by the asset management server 50.

In another embodiment the special asset request 182 will present the user with a set of questions, like a frequent ask question (FAQ) list. The user can select a question about the asset like: “why do the controls on my stove get so hot?” and the question will be given to the asset management service 50. The asset management service 50 will form an intelligent query within its own system or send it to a public forum like the Internet for answering. This would allow the user to avoid the challenge of getting on the Internet and trying to do the query themselves. Users of assets may appreciate being allowed to ask questions through the system. In this respect the asset management service 50 acts as a proxy to a complex network like the Internet to get answers to asset related questions.

In another embodiment the special asset request 182 allows the user to read the pending messages from other users of this appliance. The number of messages is shown in box 176 and indicates other users have questions or issues they want to discuss about this asset.

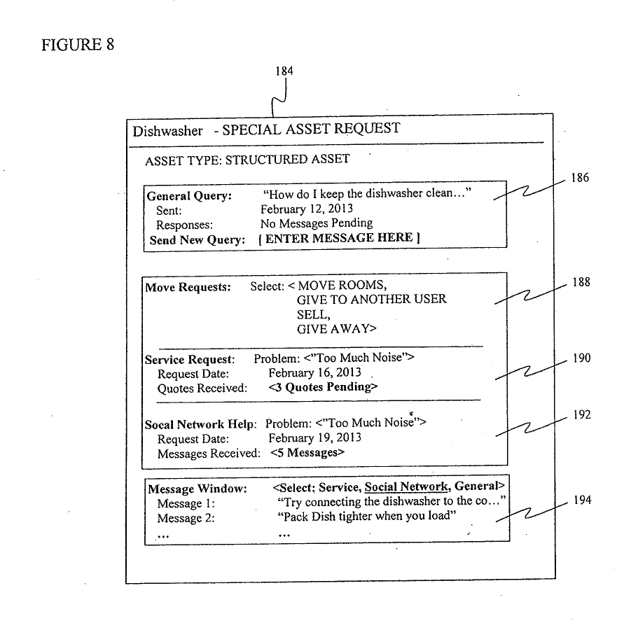

Turning now to FIG. 8 there is an illustration of performing special asset requests 184. In this exemplary embodiment the user is given a series of areas that can be used to make special asset requests. The number of boxes and the content of each box would be open for user interface selections. In this embodiment the first box 186 allows for general inquiries to the Internet or to other resources available to the asset management service 50.

The second box allows for move requests to be processed 188. The user is given a pick list where they can decide to move rooms, move the asset to another user (sale), sell the asset or give the asset away. The third box 190 allows the user to make service requests. They might enter a problem definition and be provided with a button that lets them submit the request (not shown in this illustration).

The fourth box allows the user to interact with their social network for this asset. In this example the user has decided to seek help from a service company as well as seek help from the social network for a noisy dishwasher. In the final window 194 the user can select a message area, like service messages, social network message or general Internet message to view. When this pick list is selected, the message for that area appears. In this example the Social Network area is underlined so that messages are displayed to the user.

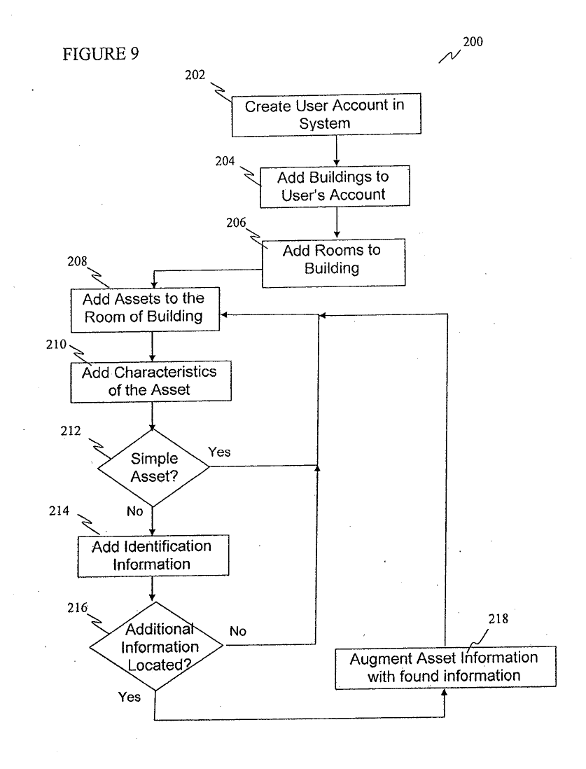

Turning now to FIG. 9 there is a flow chart for the operation of the system 200. The first step in the system 200 is for the user to create a user account for login 202. Once the login account is created the user can then add buildings to their account 204. Once buildings are added the user can start adding rooms to each building 206. In other embodiments the rooms could be floors, or cubicles or some other building division.

After rooms have been added, assets can be added to various rooms 208. The assets can be added by retails stores, the user, or through some additional method available through the asset management service 50. If the asset is a simple asset 212 then the system goes back to allow additional assets to be added 208. If the asset is not a simple asset then it is a structured asset with identification information. So the identification information is added 214 using whatever means are possible for that particular asset.

Once the identification information is added the system 200 looks for additional information 216 related to whatever detailed identification information was provided. If additional information was not found the system returns to allow the user to add additional assets 208. If additional information was located this information is augmented with the asset information already in the system 218. Once integration of the new information is complete the system returns to allow additional assets to be added 208.

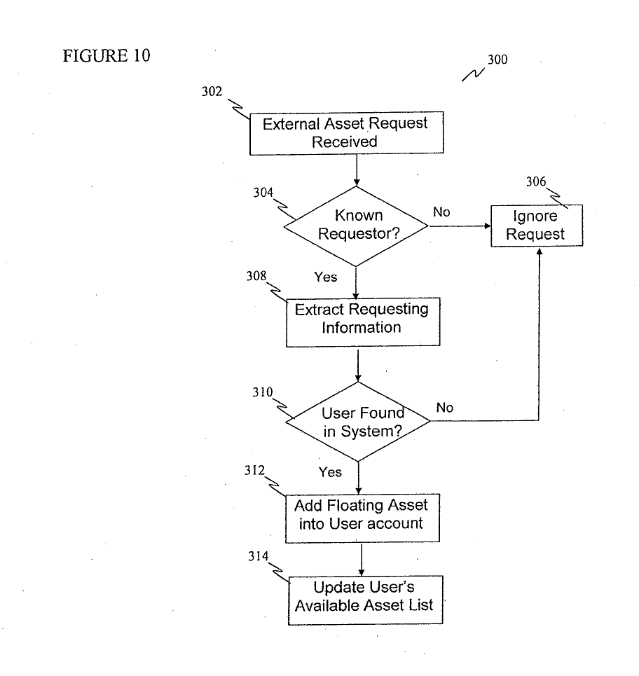

Turning to FIG. 10 there is a flow chart showing the reception of a new asset from an external source 300. In this embodiment the external source might be a retail store where the user has just purchased a new asset. In one embodiment the external source would build a request 302 using a known interface or through software provided to that external source. In another embodiment the external source might use a web interface over the Internet to enter the newly purchased asset. The next step is for the system 300 to verify if the requestor is known to the system 304. If they are not known to the system the request is ignored 306.

If they are known then the information within the request is extracted 308. In one embodiment this might involve providing a dialogue box on a web site and collecting the necessary fields. In another embodiment the external source has already scanned or acquired the asset information and is using an interface that links to the asset management service 50. Once the information is extracted the user is found in the system 310. If the user is not found in the system then no action is taken 306. Otherwise the asset is added to the user's account and treated like a floating asset 312. Effectively this means the asset is possessed by the user but does not have a location, building, floor, room, stall, hangar or known location to be place into. The total number of floating asset list is updated 314 and in some embodiments the user's display is updated with this information automatically.

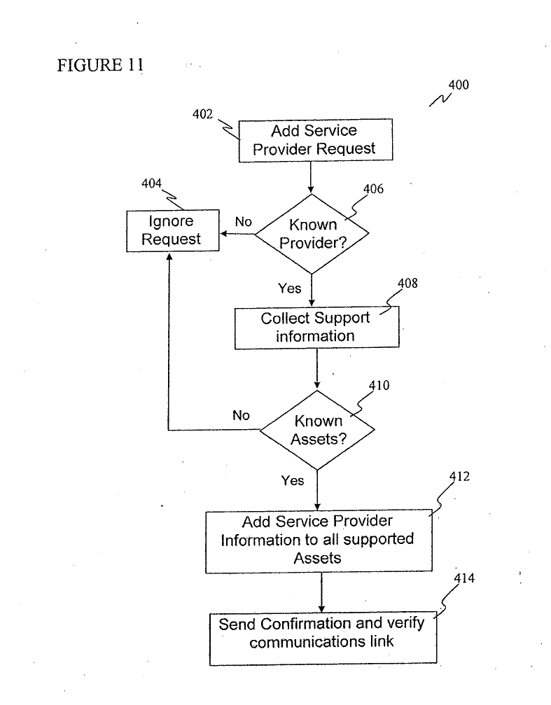

Turning to FIG. 11 there is a flow chart showing how a new service provider is added to the system 400. Firstly a request is received from a service provider to be added 402. A verification step is then undertaken to allow them into the system 406. In some embodiment the service provider would be added through an earlier phone call requesting for them to be allowed into the system, with an account name or password given to them. In other embodiments the service provider fills out a form, pays a fee, provides a paypal account, or goes through some other mechanism to verify they are reputable and no fraud is taking place. If they do not pass the test of quality and verifiability their request is ignored 404.

If the service provider has proven they are who they say they are, then information about their business and the assets they support is collected 408. If for some reason the types of assets they support are not within the system 410 then the request will be ignored 404. If the assets they support are known they are added to the Service. Provider database and cross-referenced to each asset they can perform maintenance on.

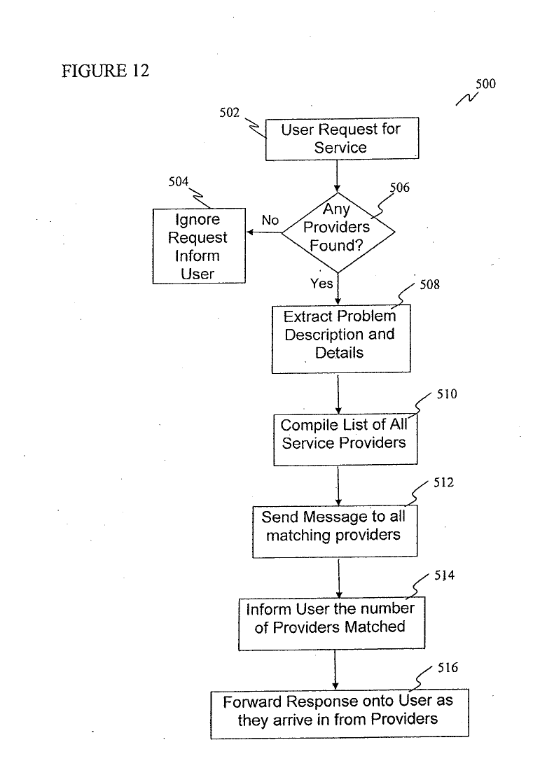

Turning to FIG. 12 there is a flow chart 500 showing the user making a request for service. Firstly a user request is received for service on an asset they own 502. A scan is performed to see if any known service providers can support that asset 506. If there are no known service providers then the request is ignored and the user is informed that no service providers were found 504. However if one or more service providers were found the information about the problem is extracted, including any details provided by the user of the problem 508. A list of all service providers is constructed 510 and a message is sent to all matching providers 512.

The user is then notified of the number of service providers that match their request 514. In an exemplary embodiment the user could also be given a sense of how long it might take for responses to be received from service providers. As responses are received from service providers they are forwarded onto the user 516.

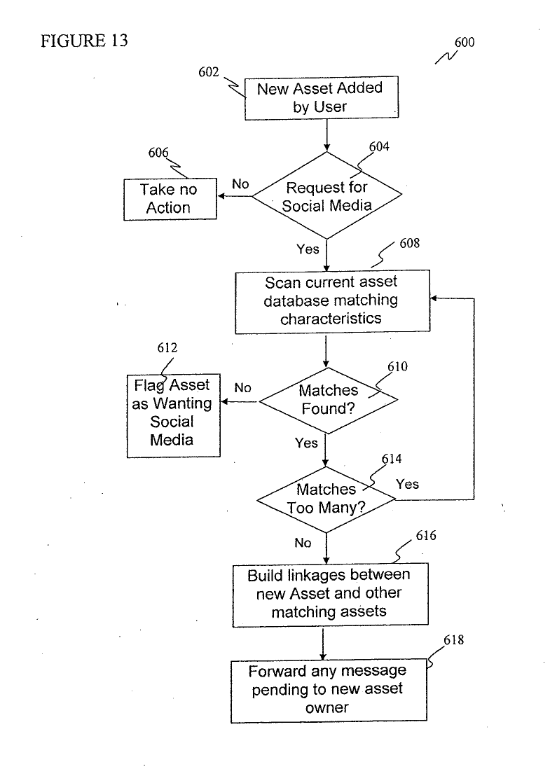

Turning to FIG. 13 there is a flow chart showing a user of an asset joining a social media group 600. In this exemplary embodiment the user has added a new asset to the system 602. After doing this they have decided to include that asset into a social media discussion with others that own a similar asset 604. In another embodiment the choice might not be given to the user and they could be automatically enrolled into social media discussion. If the user does not want to be included into social media discussions then no action is taken 606.

Otherwise the system scans known assets trying to match characteristics of similar assets 608. A check to see if any assets were found 610, if no assets were found then a flag is set to indicate the user did want this asset to be a part of social media discussions 612. Otherwise, a check is conducted to see if the number of matches may be too great 614. This programmatic number could vary from system to system and in some embodiment it might be configurable by the user, or the user might get a full list and be allowed to limit and change the parameters used in the matching process. If there are too many matches then the software returns to the scanning and matching stage 608 to further restrict which assets are considered matching. Once the correct number of assets matched is not considered too great the system builds linkages between the new asset and other matching assets within the system 616. Any pending messages for that asset are then forwarded to the owner 618.

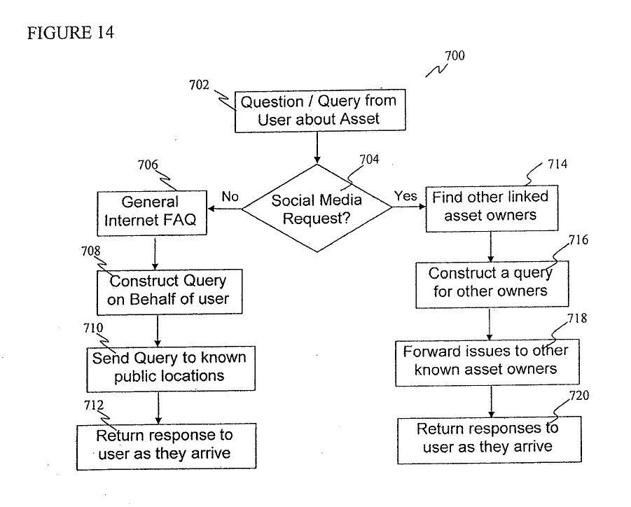

Turning to FIG. 14 there is a flow chart showing a question or query arriving from the user about an asset 700. In an exemplary embodiment the user enters a question or query from the current computer they are using 702. The question could be a specific one directed to their social media group or it could be a generic question designed for the Internet. First the system determines what type of request has been received 704. If the request is not a social media request then it is determined to be a general Internet FAQ question 706. In other embodiments it might be possible to search other knowledge databases to seek answers to questions about assets. To facility a proxy request a query is constructed on behalf of the user 708. The query is then sent to known public location 710 and in other embodiments the query is also sent to known private locations. When a response is received it is passed back to the user's account and posted to their computer if they are current logged into the system 712. If the user is currently not on the system the asset management service 50 will retain all messages and responses until they are interacting with their assets again.

If the request is a social media request 704, then the system finds the links to all other asset owners included in this social media circle 714. A message is constructed for other asset owners 716 and then the sent to their account 718. When they are connected to their account and answer the query the responses are returned to the original user that requested help 720.

Provided is a computer system for cataloguing, organizing, analyzing and utilizing the contents of a building including: providing a method for collecting information about each asset within a building using a capture method suited to that asset, organizing the collected information about each asset into groupings for later access and modification, analyzing the collected information using computing methods to extract detailed information about each asset, allowing the user to enter additional details about each asset and to correct any detailed information created by computing methods, utilizing the analyzed information about each asset to maximize the support for the contents of the building such that: using the detailed information about each asset to access database information relating to the asset, augmenting the collected information about each asset with the information retrieved from the accessed database information, retrieving detailed information about each asset with when required, merging new information with the captured information into a common record, and providing automatic summaries of information to the user managing the assets.

Collecting information may use a photographic capture method. Collecting information may use a bar code capture method. Organizing of the collected information may involve assigning each asset to a room within the building. The organizing of the collected information may involve assigning each asset to a floor within the building. The organizing of the collected information may involve distinguishing between simple assets and structured assets. The analyzed information may provide a financial value on each asset and establishes a total value of the contents of a building. The analyzed information may provide a user interface to enter a model and serial number. The analyzed information may provide an optical character recognition method for determining the model and serial number. The detailed information about each asset may include the model number and serial number of the asset.

The detailed information about each asset may include a universal product code (UPC) taken from a bar code on the asset. The augmented information may include the recall information about the asset. The augmented information may include manufacturer created information for the asset, including but not limited to: manual, warranty, schematics and specifications. The augmented information may include possible service options for the asset, including but not limited to: service companies, service company pricing, part costs, repair instructions and servicing advice.

The detailed information about each asset may provide the ability to use social media to provide interaction between different individuals that have a calculated relationship to a similar asset. The retrieval stage may allow forming intelligent queries to a third party system on behalf of a user of the system. The automatic summaries may include a presentation of total asset cost compared to the total insurance held.

In the preceding description, for purposes of explanation, numerous details are set forth in order to provide a thorough understanding of the embodiments. However, it will be apparent to one skilled in the art that these specific details are not required. In other instances, well-known structures are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for asset management, the method comprising:
receiving at least one building data;
inserting the at least one building data into an asset management database;
receiving at least one asset data associated with at least one of the at least one building data;
determining characteristics of the at least one asset data;
inserting the at least one asset data and the characteristics of the at least one asset data into the asset management database such that the at least one asset data is associated with at least one of the at least one building data;

2. A method for asset management, the method comprising:
receiving at least one building data;
inserting the at least one building data into an asset management database;
receiving at least one room data associated with at least one of the at least one building data;
inserting the at least one room data into the asset management database such that the at least one room data is associated with at least one of the at least one building data;
receiving at least one asset data associated with at least one of the at least one room data;
receiving asset characteristics about the at least one asset data;
determining whether the at least one asset data is a simple asset or a structured asset;
if the at least one asset data is a structured asset,
receiving identification data about the at least one asset;
inserting the at least one asset data, asset characteristics and identification data into the asset management database such that the at least one asset data is associated with at least one of the at least one room data;
otherwise, inserting the at least one asset data and the asset characteristics into the asset management database such that the at least one asset data is associated with at least one of the at least one room data.

3. An asset management system comprising:
an asset management database;
a user interface and management component for receiving at least one building data and receiving at least one asset data associated with at least one of the at least one building data;
an asset management and update component for:
inserting the at least one building data and the at least one asset data into the asset management database such that the at least one asset data is associated with at least one of the at least one building data, and
determining characteristics of the at least one asset data; and
a web page scraping and organization component for receiving the characteristics of the at least one asset data from the asset management and update component to retrieve data about the at least one asset data;
